(19) United States
(12) Patent Application Publication
(10) Pub. No.: US 2015/0027215 A1
(43) Pub. Date: Jan. 29, 2015

(54) TIRE TESTING MACHINE

(71) Applicant: Kabushiki Kaisha Kobe Seiko Sho (Kobe Steel, Ltd.), Kobe-shi (JP)

(72) Inventors: Takehiko WAKAZONO, Takasago-shi (JP); Yasuhiro MATSUSHITA, Takasago-shi (JP)

(73) Assignee: Kabushiki Kaisha Kobe Seiko Sho (Kobe Steel, Ltd.), Kobe-shi (JP)

(21) Appl. No.: 14/309,992

(22) Filed: Jun. 20, 2014

(30) Foreign Application Priority Data
Jul. 23, 2013 (JP) 2013-152297

(51) Int. Cl. G01M 17/02

(52) U.S. Cl. CPC G01M 17/02
USPC 73/146

(57) ABSTRACT

In order to improve general versatility that allows a user of a tire testing machine for testing a tire to flexibly change the contents of tests, a control mechanism for the tire testing machine is configured to include a tire testing controller for testing the tire according to a recipe, a changing test specification storage section for storing therein a changing test specification which is a program describing a criterion for determination of whether the order of next tests following the test described in the recipe is to be changed, as well as contents of changing of the order of the tests for the respective tests described in the recipe; and a changing determination section for determining whether the contents of the tests stored in the recipe are to be changed based on a measurement result given by the tire testing controller and the criterion for determination described in the changing test specification every time each test performed in the order described in the recipe is finished. When the test result is determined to satisfy the criterion for determination described in the changing test specification, the changing determination section is adapted to change the contents of a next test following the test according to the contents of changing the tests described in the changing test specification.

### BACKGROUND OF THE INVENTION

1. Field of the Invention

The present invention relates to a tire testing machine for testing tires.

2. Description of the Related Art

When tires mounted on motor vehicles or the like are nonuniform in elasticity, size, or shape in a circumferential direction thereof, the above nonuniform part might cause vibration in rotation at high speed, thus decreasing traveling performance. For this reason, tires undergo performance tests which examine circumferential uniformity by means of a tire testing machine after vulcanizing and molding step.

As disclosed, for example, in JP 2002-267561, a tire testing machine for performing various types of performance tests on tires include an upper rim and a lower rim for sandwiching a tire therebetween with beads on both sides thereof, a spindle for the upper rim and a spindle for the lower rim for rotatably holding the upper and lower rims around a shaft center thereof in the vertical direction, and a spindle lifting and lowering device which enables the tire to be attached or detached between the upper and lower rims by lifting and lowering at least one of the upper and lower spindles. The tire testing machine serves to test and measure the uniformity of the tire during rotation.

Various types of performance tests performed by the tire testing machine include a tire dynamic system characteristic measurement test, a tire contour shape measurement test, and the like. In these characteristic measurement tests, a tire uniformity tester is used. The tire uniformity tester is designed to press a tire chucked to the rims, against a rotary drum under a load, and to allow the tire to rotate with a distance between the spindle axis and a drum axis fixed, thereby measuring a fluctuation force (force variation) generated in the tire. A fluctuation force (radial force variation, hereinafter abbreviated to as an “RFV”) in a tire diameter direction, and a fluctuation force (lateral force variation, hereinafter abbreviated to as an “LFV”) in a width direction of a tire are mainly measured.

The fluctuation force generated from the tire is caused by non-uniformity of hardness or thickness of rubber or failure of circularity of the tire. The load applied on the tire is several hundreds of kgf in the case of a tire for a passenger car. The number of revolutions of the tire is set to 60 rpm in uniformity at low speed. Then, the fluctuation force generated in the tire is measured by rotating the tire in a normal rotation direction (CW: clockwise direction as viewed in the axial direction of the tire from the upper spindle), or in a reverse direction (CCW: counter clockwise direction as viewed in the axial direction of the tire from the upper spindle).

Such tire testing machines previously store the contents and procedure of the tests and the like in the database. According to the stored contents and the like, various types of performance tests are performed on the tire. Based on the measurement result obtained from various performance tests, the test is performed again when necessary.

### SUMMARY OF THE INVENTION

However, the order of the tests (for example, whether the CCW test is performed after the CW test) and the necessity of retesting after completion of all tests are determined based on the results of the measurement of the test in many cases. Criteria for such determination tend to change depending on a user or the like using the tire testing machine. On the other hand, a conventional tire testing machine cannot perform anything except for carrying out the tests in accordance with the predetermined order and contents. Thus, the conventional tire testing machine cannot change the predetermined test order itself based on the measurement result of the test. It is very difficult to prepare data for determining the order and contents of the tests that satisfy all the criteria for the determination which are often modified by users or the like. In this way, the conventional tire testing machine has the problem of lacking versatility.

Thus, in order to cope with the above problem, it is necessary to change the basic configuration of the test procedure for each user, or to configure special storage contents for each user, which results in high cost of programs and maintenance. Further, when the user intends to modify the basic configuration of the test procedure, a part of the program stored in a controller needs to be modified.

Accordingly, it is an object of the present invention to provide a tire testing machine for testing a tire with improved general versatility that enables the user of the tire testing machine to flexibly change the order of the test previously determined.

In order to solve the above-mentioned problems, a tire testing machine according to the invention includes: a recipe storage section for previously storing therein a recipe describing contents of a plurality of tests to be performed by the tire testing machine for testing a tire and an order of the tests; a tire testing controller for testing the tire by the tire testing machine in the order of the tests described in the recipe in accordance with the contents of the tests described in the recipe; a changing test specification storage section for storing therein as a changing test specification, a program describing a criterion for determination of whether the contents of next tests following the test described in the recipe is to be changed, as well as contents of changing of the tests for the respective tests described in the recipe; an input device for inputting the changing test specification in the changing test specification storage section; and a changing determination section for changing the contents of a next test following the test according to the contents of changing of the test described in the changing test specification every time each test is performed on the tire by the tire testing controller when a test result is determined to satisfy the criterion for determination described in the changing test specification based on the test result and the changing test specification.

In this way, when it is determined that the order of the tests does not need to be changed by the changing determination section based on the result of the respective tests performed according to the recipe and the criterion for determination described in the changing test specifications, the tests are performed on the tire in the order described in the recipe. On the other hand, when the contents of a next test following the test is determined to be changed by the changing determination section based on the results of the respective tests and the criterion for determination described in the changing test specification, the contents of the next test following the above test are changed based on the contents of changing of the test described in the changing test specification according to the user specifications. Therefore, the user can change the contents of the test so as to meet the desired test result at any time only by setting the changing test specifications without changing the basic configuration of the recipe for each user and without configuring a special recipe for the user, which can change the contents of the tests flexibly, while reducing the time for the program and maintenance time, thereby improving the general versatility.

The changing test specifications in the tire testing machine may further include a criterion for determination of whether the test described in the recipe is performed again or not, and contents of retesting based on a test result after all the tests described in the recipe are performed, and the changing determination section may be adapted to set retesting according to the contents of the retesting described in the changing test specification when the test result is determined to satisfy the criterion for determination described in the changing test specification based on the test result and the changing test specification after all the tests described in the recipe are performed.

With this arrangement, when the retesting is determined to be performed based on a series of results of the tests described in the recipe and the criterion for determination in the changing test specifications, the tire is retested by the tire testing machine according to the contents of the retesting described in the changing test specifications. Therefore, the user can retest the tire so as to meet the desired test result at any time only by setting the changing test specifications without changing the basic configuration of the recipe for each user and without configuring a special recipe for the user, which can change the order of the tests flexibly, while reducing the time for the program and maintenance time, thereby improving the general versatility.

### BRIEF DESCRIPTION OF DRAWINGS

FIG. 1 is a side view showing a tire testing machine in one embodiment;

FIG. 2 is a plan view showing the tire testing machine of the one embodiment;

FIG. 3 is a block diagram showing a control mechanism in the tire testing machine in the one embodiment;

FIG. 4 is a diagram showing a screen image of a display device in the tire testing machine in the one embodiment; and

FIG. 5 is a diagram showing another example of the screen image of the display device in the tire testing machine in the one embodiment.

### DESCRIPTION OF THE PREFERRED EMBODIMENTS

In the following, preferred embodiments for applying a tire testing machine according to the present invention will be described based on one specific example with reference to the accompanying drawings.

The embodiments described below are illustrative only, and are not intended to limit the application of the tire testing machine according to the invention. That is, the tire testing machine of the invention is not limited to the following embodiments, and various modifications and changes can be made to those embodiments within the scope of claims of the invention.

### (Structure of Tire Testing Machine)

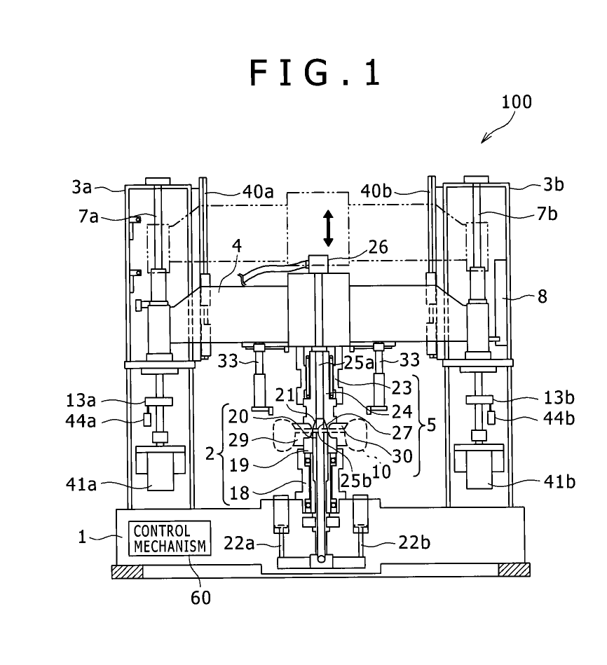

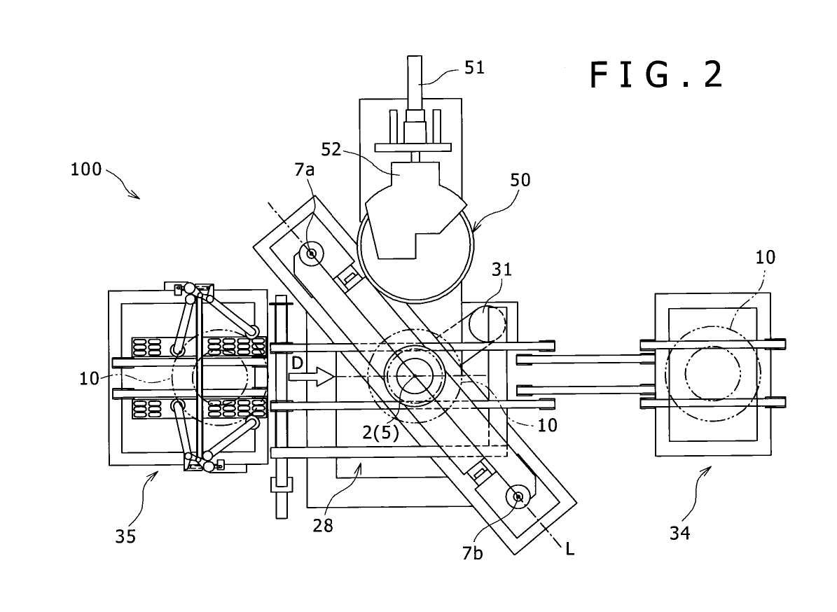

First, the structure of a tire testing machine 100 according to one embodiment will be described with reference to FIGS. 1 and 2.

As shown in FIG. 2, the tire testing machine 100 includes an inlet conveyer 35, a center conveyer 28, and an output conveyer 34. The respective conveyers 35, 28, and 34 are disposed to deliver a tire 10 of interest for testing in a conveyance direction D.

As shown in FIG. 1, the tire testing machine 100 includes a lower frame 1, a pair of vertical frames 3a and 3b mounted on the lower frame 1, linear guides 40a and 40b serving as a sliding guide portion attached to the vertical frames 3a and 3b, a movable beam 4 straddling a gap between the linear guides 40a and 40b, a lower chuck 2 serving as a fixed chuck mounted on the lower frame 1, and an upper chuck 5 serving as a mobile chuck mounted on the movable beam 4.

The lower frame 1 is formed, for example, of a weld-bonded structure of steel plates, or an H-type or I-type steel material, and extends horizontally.

The vertical frames 3a and 3b are formed, for example, of a weld-bonded structure of steel plates, or a square steel pipe, and fixed to the upper surface of the lower frame 1 via bolts and nuts and the like. The vertical frames 3a and 3b are fixed to both ends of the lower frame 1, and extend upward in the vertical direction from the lower frame 1. Linear guides 40a and 40b are attached to opposed sides of the vertical frames 3a and 3b, respectively. Ball screws 7a and 7b (screw shafts) are attached to the vertical frames 3a and 3b, respectively. The ball screws 7a and 7b extend vertically within internal spaces of the vertical frames 3a and 3b, respectively.

The movable beam 4 is formed, for example, of a weld-bonded structure of steel plates, or an H-type or I-type steel material. The movable beam 4 has both ends thereof connected to the nuts of the ball screws 7a and 7b. The movable beam 4 is supported by the pair of vertical frames 3a and 3b via the ball screws 7a and 7b and the linear guides 40a and 40b. The movable beam 4 is lifted or lowered by rotation of the ball screws 7a and 7b, while being guided by the linear guides 40a and 40b. The position of the movable beam 4 in the vertical direction is detected by a linear sensor 8 provided on either of the vertical frames 3a and 3b (vertical frame 3b in this embodiment). Alternatively, encoder signals from the motors 41a and 41b can be used for detection of the position in the vertical direction.

The lower ends of the ball screws 7a and 7b are directly coupled to the motors 41a and 41b, respectively. These motors 41a and 41b cause the ball screws 7a and 7b to rotate. The motors 41a and 41b are driven in synchronism with each other.

Circular disks 13a and 13b with a number of holes 14 formed in the disks are provided between the motors 41a and 41b of the ball screws 7a and 7b, and the movable beam 4, respectively. The circular disks 13a and 13b are fixed to the parts between the motors 41a and 41b of the ball screws 7a and 7b, and the movable beam 4, respectively. The center of each of the circular disks 13a and 13b conforms to the shaft center of each of the ball screws 7a and 7b. The hole 14 may be a long hole or an exact circular hole. The number, size, and arrangement (distance from the center of the circular disks 13a and 13b and the like) of the hole 14 is determined based on a pitch between the ball screws 7a and 7b.

Pins driven by air cylinders 44a and 44b are operable to be inserted into the holes 14 of the respective circular disks 13a and 13b, thereby respectively fixing the circular disks 13a and 13b, which stop the rotation of the ball screws 7a and 7b. Thus, the circular disks 13a and 13b and the holes 14 thereof, the air cylinders 44a and 44b, and the pins driven by the air cylinders 44a and 44b serve as a movable beam stopping mechanism. When air or gas (nitrogen gas or the like) is supplied to the internal space of the tire 10 sandwiched between the lower chuck 2 and the upper chuck 5, the above stopping mechanism fixes the movable beam 4 so as not to lift the movable beam 4 upward. Thus, the upper chuck 5 is fixed to the lower chuck 2 via the movable beam 4 in such a manner as not to be lifted upward.

The air cylinders 44a and 44b include a cylinder main body, and a pin having a circular cross-sectional shape. The respective pins included in the air cylinders 44a and 44b are designed to proceed and retreat with respect to the cylinder main body due to the pressure of air supplied to and discharged from the cylinder main body. The cylinder main body included in the air cylinders 44a and 44b, and the pin guide structure are respectively fixed to static members (fixed members), such as the vertical frames 3a and 3b. With this arrangement, the pins become unmovable in the rotation direction of the circular disks, and then can stop the rotation of the circular disk after being inserted into the circular disks 13a and 13b.

Instead of the air cylinders 44a and 44b, a hydraulic cylinder or the like may be used. Alternatively, a worker may manually insert pins into the holes 14 of the circular disks 13a and 13b.

The upper chuck 5 is attached to the movable beam 4 so as to extend downward from a lower surface of the movable 4 at a center thereof in the longitudinal direction.

The upper chuck 5 includes an outer housing 23 fixed to the movable beam 4, an upper spindle 24 rotatably disposed within the outer housing 23, an upper rim 30 fixed to the outer periphery of a lower end of the upper spindle 24, and a female tapered portion 27 formed at the center of the lower end of the upper spindle 24 and opened and expanded downward in the vertical direction.

A male tapered portion 21 formed at the upper end of a plunger 20 of the lower chuck 2 to be described later is inserted into and engaged with the female tapered portion 27. The female tapered portion 27 of the lower end of the upper spindle 24, that is, the inner side surface of the lower end of the upper spindle 24 is formed as an inclined surface that is inclined in the vertical direction at the same angle as the upper end of the plunger 20.

The upper rim 30 is disposed to surround the lower end of the upper spindle 24, and is rotatable around the shaft extending in the vertical direction together with the upper spindle 24.

The inside of the upper spindle 24 is provided with an air supply passage 25a serving as a hole through which air passes from the upper end of the upper spindle to the lower end thereof along the vertical direction. The air supply passage 25a is connected to a rotary joint 26 disposed at the upper end of the movable beam 4.

The lower chuck 2 is attached to the lower frame 1 so as to extend upward from an upper surface of the lower frame 1 at a center thereof in the longitudinal direction.

The lower chuck 2 includes an outer housing 18 fixed to the lower frame 1, a lower spindle 19 rotatably disposed within the outer housing 18, a plunger 20 capable of extending and contracting and which is disposed within the lower spindle 19, and a lower rim 29 fixed to the upper end of the lower spindle 19.

The lower spindle 19 is connected to the spindle motor 31 shown in FIG. 2 via a timing belt. The lower spindle 19 rotates around the shaft extending along the vertical direction by driving the spindle motor 31. The number of revolutions of the lower spindle 19 is controlled by the spindle motor 31. The plunger 20 is capable of rotating around the shaft extending in the vertical direction, together with the lower spindle 19, while the lower spindle 19 is not capable of being extended and contracted in the vertical direction. In contrast, the plunger 20 is capable of being extended and contracted (relatively moving with respect to the lower spindle 19) in the vertical direction by driving the air cylinders 22a and 22b.

The plunger 20 is formed of a stick-like member, the upper end of which is provided with a tapered convex portion (male tapered portion) 21 having an inclined surface whose outer side is inclined in the vertical direction so as to be narrowed toward its tip end. The lower rim 29 is disposed to surround the upper end of the lower spindle 19, and is rotatable around the shaft extending in the vertical direction together with the lower spindle 19.

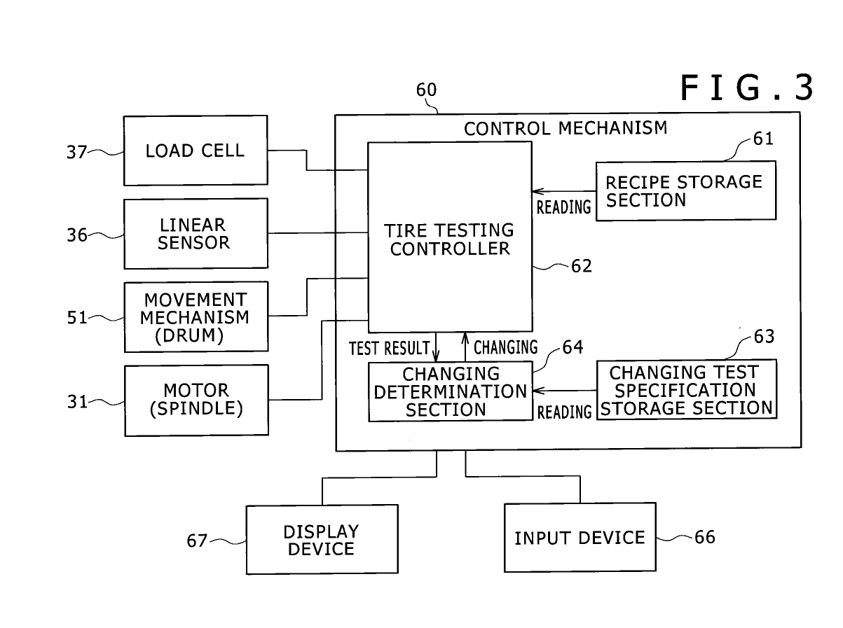

To a guide member (not shown) of the plunger 20, a linear sensor (see FIG. 3) 36 is attached. The guide member is fixed to the plunger 20, and moves together with the plunger 20. The linear sensor 36 is a sensor for detecting the position (position in the vertical direction) of the upper chuck 5 (upper rim 30) with respect to the lower chuck 2 (lower rim 29), and is regarded as a digital linear sensor. The digital linear sensor has a high resolution. Thus, the use of the digital liner sensor can detect the position of the upper chuck 5 (upper rim 30) with respect to the lower chuck 2 (lower rim 29) with high accuracy. The amount of extension of the plunger 20 positions the upper chuck 5 with respect to the lower chuck 2. In the position determined, the pins are inserted into the holes 14 of the circular disks 13a and 13b.

The linear sensor 36 does not need to be of a digital type, and may use an analogue linear sensor. The linear sensor 36 is attached to the plunger 28 itself, but may be a digital or analogue linear sensor incorporated in the air cylinders 22a and 22b. In order to detect both the stroke ends of the plunger 20, a limit switch may be formed on both the stroke ends. A linear sensor 8 provided in the vertical frame 3b may be used for the purpose of detecting the position of the upper chuck 5 with respect to the lower chuck 2. The encoder output of the motors 41a and 41b may be used to detect the position of the upper chuck 5 with respect to the lower chuck 2.

An air supply passage 25b is provided inside the upper end of the plunger 20. The air supply passage 25b is a passage for communicating the air supply passage 25a provided in the upper spindle 24 with the internal space of the tire 10.

The upper chuck 5 and the lower chuck 2 are disposed in a position opposed to each other in the vertical direction at the center in the longitudinal direction of the lower frame 1. That is, the rotary shafts of the lower spindle 19 of the lower chuck 2, the plunger 20, and the lower rim 29 are identical to that of the upper spindle 24 of the upper chuck 5, and the rotary shaft of the upper rim 30.

Further, in the lower spindle 19, a load cell 37 (see FIG. 3) is disposed to detect a pressing load on the tire 10 by a drum 50 to be described later.

### (Structure of Drum of Tire Testing Machine)

Next, the structure of a drum 50 of the tire testing machine 100 will be described with reference to FIG. 2.

The drum 50 has a flat cylindrical shape, and a rotational shaft at its center. The drum 50 is rotatably supported by a support frame 52 in the vertical direction. Alternatively, a motor (not shown) for rotating the drum 50 can be coupled to the lower or upper end of the rotation shaft of the drum 50.

The support frame 52 includes a movement mechanism 51. The movement mechanism 51 horizontally moves the drum 50 in the direction substantially perpendicular to the conveyance direction D via the support frame 52, that is, can move the drum 50 together with the support frame 52 in a horizontal direction, namely, in the approaching and departing directions with respect to the tire 10 sandwiched between the lower spindle directions with respect to the tire 10 sandwiched between the lower spindle 19 of the lower chuck 2 and the upper spindle 24 of the upper chuck 5. The movement mechanism can include a ball screw or an air cylinder as a feeding portion, and a linear rail way with rollers or a rail with a machined surface facing together as a guide portion.

### (Structure of Control Mechanism of Tire Testing Machine)

Next, the structure of a control mechanism 60 of the tire testing machine 100 will be described with reference to FIGS. 3 to 5.

As shown in FIG. 3, the control mechanism 60 includes a combination of a plurality of components, including a PLC, a motion controller, a personal computer, and the like. The control mechanism 60 includes a recipe storage section 61, a tire testing controller 62, a changing test specification storage section 63, and a changing determination section 64. The tire testing controller 62 is connected to the spindle motor 31, the movement mechanism (drum) 51, the linear sensor 36, and the load cell 37. The tire testing controller 62 is adapted to give a command of the contents set in the recipe to each component of the tire testing machine 100, thereby performing the test. Further, an input device 66 and a display device 67 are connected to the control mechanism 60.

The linear sensor 36 is adapted to sense the tire 10 sandwiched between the lower spindle 19 and the upper spindle 24 to output a sensing signal to the tire testing controller 62. The load cell 37 is adapted to sense the contact of the tire 10 with the drum 50 to output a sensing signal to the tire testing controller 62.

The spindle motor 31 rotates the tire 10 sandwiched between the lower spindle 19 and the upper spindle 24 based on the command from the tire testing controller 62. The movement mechanism 51 moves the drum 50 based on the command from the tire testing controller 62.

The input device 66 is, for example, a keyboard or mouse connected to the outside of the control mechanism 60. The display device 67 is, for example, a monitor connected to the outside of the control mechanism 60.

The tire testing machine 100 performs the test based on the recipe previously stored. The term “recipe” as used herein means a setting table that describes the contents of tests (including the procedure of the test and the like) performed by the tire testing machine. For example, for a uniformity test, the recipe describes therein information on the tire size, information on parameters for the test (inner pressure of a tire, load thereof, a tire conveyance speed, and the like), the order and contents of the tests, and the like. The recipe storage section 61 is a part for storing therein the recipe previously input. Methods for selecting the recipe stored include a method for manually reading out a recipe stored in the control mechanism 60 to set the read recipe in the control mechanism 60, a method for selecting a recipe corresponding to information on type of the tire 10 input from a higher controller (not shown), from a group of recipes stored in the control mechanism 60, a method for downloading a recipe corresponding to the type of the tire 10 from the higher controller (not shown) into the control mechanism 60. The parameters may be previously described not to be changed.

The tire testing controller 62 is a device for causing the tire testing machine 100 to perform the test on the tire 10 according to the contents and order of the tests described in the recipe.

Specifically, when the linear sensor 36 senses the tire 10 sandwiched between the lower spindle 19 and the upper spindle 24, and a sensing signal is input to the tire testing controller 62, the tire testing controller 62 starts the testing of the tire. The tire testing controller 62 performs the tests on the tire 10 sandwiched between the lower spindle 19 and the upper spindle 24 in the order described in the recipe based on the contents of the respective tests (load, contents of the tire characteristics to be measured, rotation direction of the tire (CW direction/CCW direction), and the like). More specifically, the spindle motor 31 is driven to rotate in a predetermined direction (CW or CCW) at the predetermined number of revolutions. The tire testing controller 62 moves the drum 50 by the movement mechanism 51 until a sensing signal indicative of contact with the tire 10 rotating at the predetermined number of revolutions is sensed by the load cell 37 and input to the controller. When the sensing signal indicating the contact of the tire 10 with the drum 50 and sensed by the load cell 37 is input to the tire testing controller 62, the tire testing controller 62 drives the spindle motor 31 such that the rotation of the tire 10 sandwiched between the lower spindle 19 and the upper spindle 24 is accelerated at a predetermined acceleration based on the recipe up to the prescribed number of revolutions. Further, the tire testing controller 62 moves the drum 50 by means of the movement mechanism 51 until a load of the drum 50 on the tire 10 sensed by the load cell 37 reaches a testing load based on the recipe. The use of the load cell 37 measures an RFV and an LFV. The measurement result is stored in a storage device (not shown).

The changing test specification storage section 63 stores therein the changing test specifications (script) as a program describing the criterion for determination of whether the order of next tests following the test described in the recipe is to be changed for the respective tests described in the recipe, as well as the contents of changing of the order of the tests. That is, based on the criterion for determination according to the measurement result of a tire test performed by the tire testing controller 62 in response to each test described in the recipe, the changing test specifications describes therein the specifications about changing the order of next tests following the test or the presence or absence of a next test. Further, the changing test specifications may include another criterion for determination of whether to perform the test described in the recipe again based on the test result, and the contents of the retesting after all the tests described in the recipe. The changing test specifications are preferably described by using the Lua script language. The changing test specifications describe that, for example, when a criterion for determination regards whether the measurement result of the test performed according to the recipe by the tire testing controller 62 is equal to or more than a predetermined result, and the criterion for determination is satisfied, a next test planed to follow the test is skipped, resulting in the end of all the tests. Further, the changing test specifications describe that when a criterion for determination regards whether the measurement result of all the tests is equal to or less than a predetermined result after performing all the test by the tire testing controller 62 according to the recipe, and the criterion for determination is satisfied, the test according to the same recipe is performed again from the beginning.

The changing determination section 64 determines whether or not the order of the tests stored in the recipe or the like is to be changed based on the measurement result by the tire testing controller 62 and the criterion for determination described in the changing test specification every time each test is finished in the order described in the recipe. When the test result is determined to satisfy the criterion for determination described in the changing test specifications, the changing determination section 64 gives the tire testing controller 62 a command to change the order of next tests following the test or the like according to the contents of changing the test described in the changing test specifications. When the changing test specification describes the criterion for determination of whether the test described in the recipe is performed again and the contents of the retesting based on the test result after all the tests described in the recipe are performed, the changing determination section 64 is adapted to determine whether or not the same test is performed again based on the measurement result of each test by the tire testing controller 62 and the criterion for determination described in the changing test specifications after all the tests described in the recipe are performed. When the test result is determined to satisfy the criterion for determination described in the changing test specifications, the changing determination section 64 gives the tire testing controller 62 the command to perform the test again according to the contents of retesting described in the changing test specifications. Further, after all the tests described in the recipe are finished, the changing determination section 64 may display the measurement result on the display device 67, and may allow the user to select one of a plurality of changing test specifications. In this case, the user commands the determination result to the tire testing controller 62 via the input device 66.

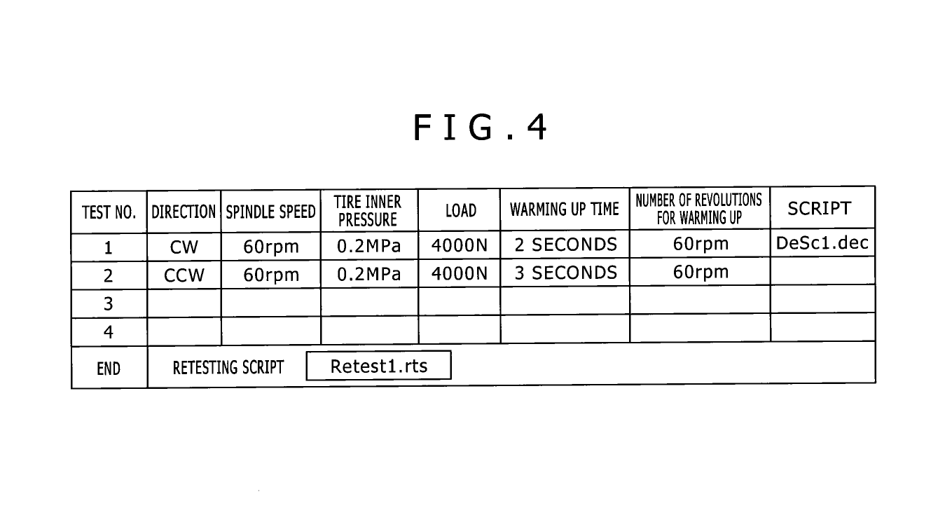

Specifically, as shown in a screen image of FIG. 4, the display device 67 displays, among the recipe, the order of performing the tests (column for a test No.), and its contents (columns for direction, spindle speed, tire inner pressure, load, warming up time, and number of revolutions for warming up). The script (changing test specification) is described by a file name thereof in a column for the order changing script located on the most right side for each test. For example, as described in the script of a test No. 1, when a rank of the measurement result of the RFV in the test No. 1 is A among the ranks A to E, a next test No. 2 after this test is skipped, resulting in the end of all the tests.

As shown in a screen image of FIG. 4, the display device 67 describes the script describing whether the same test is performed again from the beginning based on the measurement result of each test as a file name in a lowest column for a retesting script of the recipe after all the test described in the recipe are finished. For example, when the measurement result of the total rank is E among the ranks A to E, this script describes that the tests described in the recipe are performed again from the beginning.

In the example shown in FIG. 4, when the file name is not described in the right column for the order changing script in each test, or in the lowest column for the retesting script of the recipe, the changing determination section 64 does not perform the determination, and in each case, a next test is performed, or the testing is finished.

In this way, in the tire testing machine 100 of this embodiment, when it is determined that the order of the tests or the like does not need to be changed by the changing determination section 64 based on the result of the respective tests performed according to the recipe and the criterion for determination described in the changing test specifications, the tests are performed on the tire 10 in the order described in the recipe. When the order of next tests following the test is determined to be changed by the changing determination section 64 based on the results of the respective tests and the criterion for determination described in the changing test specification, the order of next tests following the test is changed based on the contents of changing a test described in the changing test specifications that complies with user specifications. Therefore, the user can change the test so as to meet the desired test result at any time only by setting the changing test specifications without changing the basic configuration of the recipe for each user and without configuring a special recipe for the user, which can change the order of the tests flexibly, while reducing the time for the program and maintenance time, thereby improving the general versatility.

When the retesting is determined to be performed based on a series of test results described in the recipe and the criterion for determination in the changing test specifications, the tire 10 is retested by the tire testing machine 100 according to the contents of the retesting described in the changing test specifications. Therefore, the user can retest the tire so as to meet the desired test result at any time only by setting the changing test specifications without changing the basic configuration of the recipe for each user and without configuring a special recipe for the user, which can change the order of the tests flexibly, while reducing the time for the program and maintenance time, thereby improving the general versatility.

Since the changing test specification is described by the general Lua scripting language, the test testing machine has improved general versatility and reliability.

Although the preferred embodiments of the present invention have been described above, the invention is not limited to those embodiments, and various modifications and changes can be made to those embodiments within the scope of claims of the invention.

In the above-mentioned tire testing machine 100 of this embodiment, the criterion for determination described in the changing test specifications may include, for example, a step of a test, a numerical value of each measurement result of a test, a rank corresponding to the each measurement result of the test, a tire rank after the test, a waveform order of the numerical value of each measurement result of a test, a tire inner pressure state in measurement, a load state, a tire outer diameter, and a tire width. Additionally, various parameters used in the tire testing machine 100 can be used for determination.

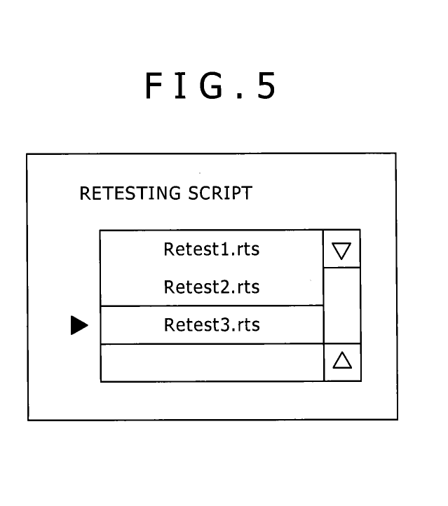

As shown in the screen image of FIG. 4, in the tire testing machine 100 of this embodiment described above, the display device 67 describes the script describing whether the same test is performed again from the beginning based on the measurement result of each test (changing test specification) as a file name in a lowest column for a retesting script of the recipe after all the tests described in the recipe are finished. However, the invention is not limited thereto. For example, after all the tests described in the recipe are finished, a screen for selecting a file of a script shown in FIG. 5 may be displayed, and based on the screen of FIG. 5, a file of the script for retesting may be selected.

What is claimed is:

1. A tire testing machine, comprising:
a recipe storage section for previously storing therein a recipe describing contents of a plurality of tests to be performed by the tire testing machine for testing a tire and an order of the tests;
a tire testing controller for testing the tire by the tire testing machine in the order of the tests described in the recipe in accordance with the contents of the tests described in the recipe;
a changing test specification storage section for storing therein as a changing test specification, a program describing a criterion for determination of whether the contents of next tests following the test described in the recipe is to be changed, as well as contents of changing of the tests for the respective tests described in the recipe;
an input device for inputting the changing test specification in the changing test specification storage section; and
a changing determination section for changing the contents of a next test following the test according to the contents of changing of the test described in the changing test specification every time each test is performed on the tire by the tire testing controller when a test result is determined to satisfy the criterion for determination described in the changing test specification based on the test result and the changing test specification.

2. The tire testing machine according to claim 1, wherein the changing test specification further includes a criterion for determination of whether the test described in the recipe is performed again or not, and contents of retesting based on a test result after all the tests described in the recipe are performed, and
wherein the changing determination section is adapted to set retesting according to the contents of the retesting described in the changing test specification when the test result is determined to satisfy the criterion for determination described in the changing test specification based on the test result and the changing test specification after all the tests described in the recipe are performed.
